(19) United States
(12) Patent Application Publication
(10) Pub. No.: US 2013/0253886 A1
(43) Pub. Date: Sep. 26, 2013

(54) DATA CENTER INTEGRATED PIPING SOLUTION FOR HIGH-DENSITY-COOLING

(71) Applicants: Raam Kuumar Chandrasekar, TamilNadu (IN); Abhay B. Singh, Karnataka (IN)

(72) Inventors: Raam Kuumar Chandrasekar, TamilNadu (IN); Abhay B. Singh, Karnataka (IN)

(73) Assignee: INTERNATIONAL BUSINESS MACHINES CORPORATION, Armonk, NY (US)

(21) Appl. No.: 13/424,444

(22) Filed: Mar. 20, 2012

(51) Int. Cl. G06F 17/50

(52) U.S. Cl. 703/1

(57) ABSTRACT

A method and a computer program product for generating a data center component layout includes inputting data for a data center component layout into a computer having a processor for executing a software program tool embodied therein. The processor executes the steps of the software program tool including the following steps. The method includes generating a component layout for a data center having a plurality of components. The components include heat generating units, and the data center has data center parameters including data center dimensions, and data center square footage. The method includes calculating cooling system requirements for the component layout in the data center. The method further includes generating a cooling system layout for the components of the data center, and generating a data center component layout design including the positioning of the component and positioning of the cooling system.

### FIELD OF THE INVENTION

The present invention relates to a method for generating a data center layout and design, and more specifically, relates to a method for automatically generating a data center layout and design in a high density data center.

### BACKGROUND OF THE INVENTION

Data centers including multiple racks of computers or computer components may be considered high density. Typically, rear door heat exchanger based cooling solutions are one of the cooling technologies used in a data center. The current design process of a data center layout is manual, complicated and time consuming. Further, known designs do not take into account a possible failure of cooling units, distribution units, and the impact on cooling in the data center of such failures.

It would therefore be desirable to provide a method for designing a datacenter component layout which is efficient, less time consuming, automated, and accounts for possible failures of cooling units, distribution units or related components which can have an affect on meeting data center cooling requirements.

### SUMMARY OF THE INVENTION

The present invention provides a solution to the shortcomings of current methods and systems by providing a method including a tool for providing an automatic reliable solution—data center component layout design, wherein the tool receives input data.

According to an aspect of the invention, a method for generating a data center component layout comprises: inputting data into a computer for a data center component layout of a data center having a plurality of components, the computer having a processor for executing a software program tool embodied therein, the inputted data including data center parameters including data center dimensions, and data center square footage, and the processor executing the steps of the software program tool including the following steps; generating the data center component layout positioning the plurality of components, the components including heat generating units; calculating requirements for a cooling system for the component layout in the data center; generating a cooling system layout for the components of the data center; and generating a data center component layout design including the positioning of the components and positioning of the cooling system.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram of a method for generating a data center layout according to an embodiment of the invention;

FIG. 2 is a schematic block diagram of a computer used for calculating the data center layout and a data center with components in accordance with the embodiment of the invention depicted in FIG. 1;

FIG. 3 is a schematic block diagram of a data center layout according to one embodiment of the invention;

FIG. 4 is a schematic block diagram of a data center layout according to another embodiment of the invention;

FIG. 5 is an isometric view of a server racks and a central distribution unit according to an embodiment of the invention;

FIG. 6 is a schematic block diagram of the server rack and the central distribution unit of FIG. 5 including rear door heat exchangers; and

FIG. 7 is a schematic block diagraph of an embodiment of a computer environment for use by a computer program incorporating a method according to an embodiment of the present invention.

### DETAILED DESCRIPTION OF THE INVENTION

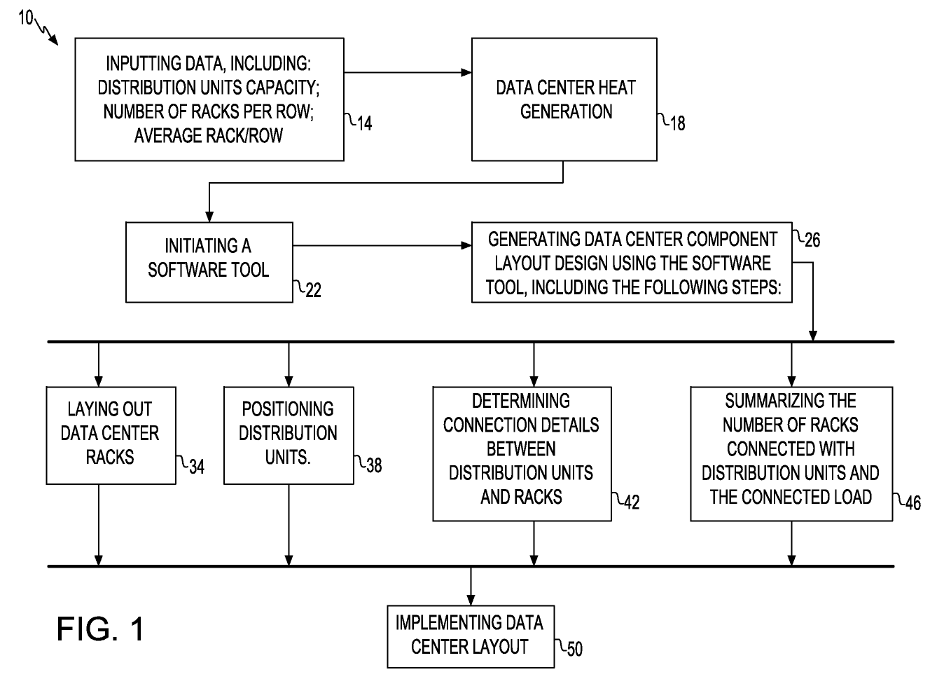

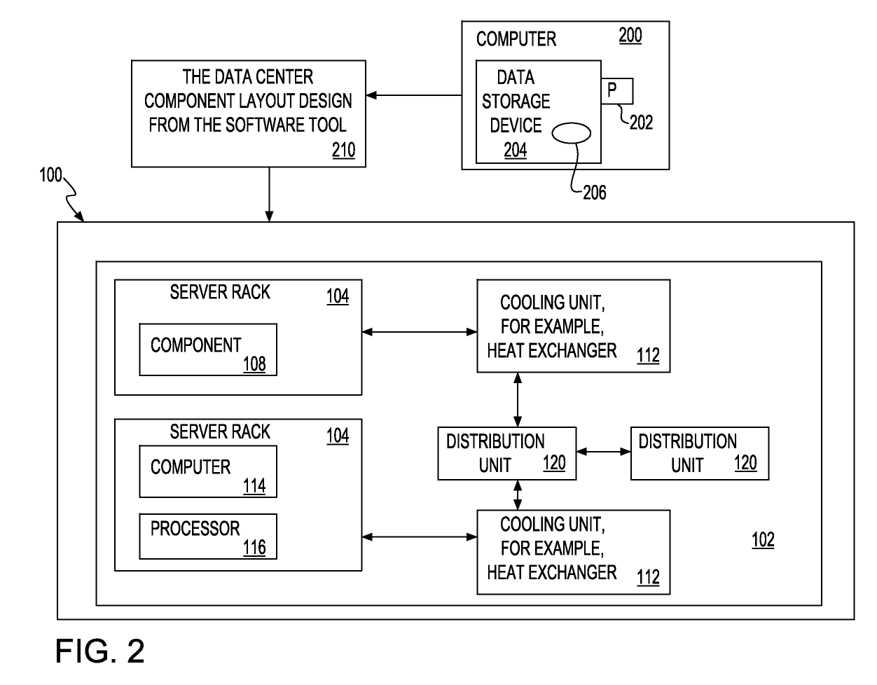

In one embodiment of the invention, referring to FIGS. 1 and 2, a method 10 for generating a data center component layout design 210 for a data center 100 may be initiated using a tool embodied as a software tool 206 (FIG. 2) in step 22. The method 10 further includes inputting data into the software tool 206 in step 14. The data input of step 14 may include distribution unit capacity, the number of server racks per row of server racks, and the average number of server racks per row of server racks. The method 10 further includes calculating the data center heat generation for the components in step 18. Once the data is inputted into the software tool 206, and preliminary calculations are executed such as the data center heat generation of step 18, the software tool may be initiated in step 22 to generate a data center component layout design 210 in step 26, which includes steps 34-46, for implementation in step 50.

In an embodiment of the invention, the software tool 206 of the method 10 calculates the layout of server racks in step 34. Also, the software tool 22 calculates the positioning of distribution units in step 38, and calculates connection details between distribution units to the racks in step 42, such as piping distribution between the distribution units and heat exchangers. Further, the software tool 206 calculates a summary of the number of racks connected with distribution units and the connected load, that is, the heat load from the components 108.

The tool may be embodied as the software program 206, as discussed above, and may also be referred to as a software program tool or a software tool. The data center component layout design 210 (FIG. 2), is embodied in datacenter component layout 102 which has a plurality of components 108, wherein the components generically represents a plurality of heat producing units. The layout design 210 may include a schematic representation of the layout, using any number of icon, colors, representations, flowchart symbols, etc. The component layout 102 includes physical layout of components 108 in racks 104 in the data center 100, for example, as shown in FIG. 2, the layout 102 includes: computer racks 104, cooling units 112 for a cooling system, distribution units 120 for distributing coolant from the cooling units 112, and piping connections or distribution between components including fluid connections between the distribution units 120 and the cooling units 112. The components 108 may be embodied as a computer 114, or a processor 116, or other components, such as data storage devices (not shown). The components generate heat which needs to be dissipated to maintain desirable heat levels in the data center 100. The present disclosure provides an embodiment of the invention to solve the above problem as shown in the data center component layout 102.

In one example, the software tool 206 shown in FIG. 2 may be saved on a data storage device 204 of a computer 200, and may be executed by a processor 202, as part of a system 90 for generating the data center component layout design 210. The software tool 206 generates the data center component layout design 210 using a methodology which may include logic or equations. The software tool 206 may use software or a computer program using a selected programming language from available programming languages in the programming arts. The data center component layout design 210 may be drawn using a software program, for example, Excel™, and include a data center rack layout including racks 104, wherein the racks 104 house components 108 which may include computers 114, or processors 116, or other computer or computer related units or components. The data component layout 26 may also include distributing units 120 for connecting server racks.

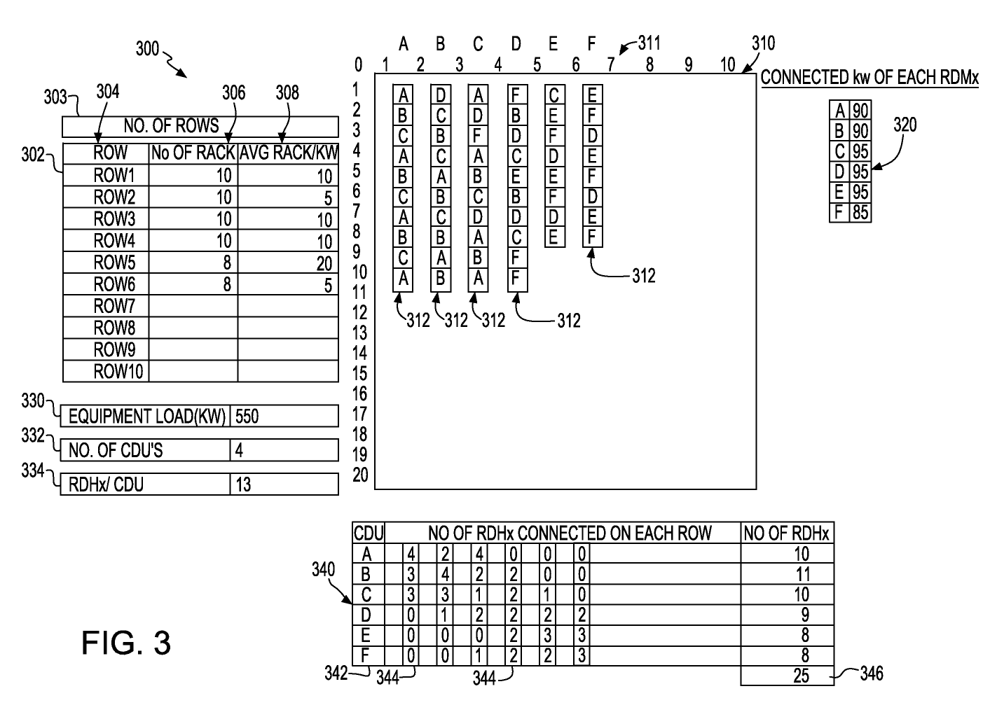

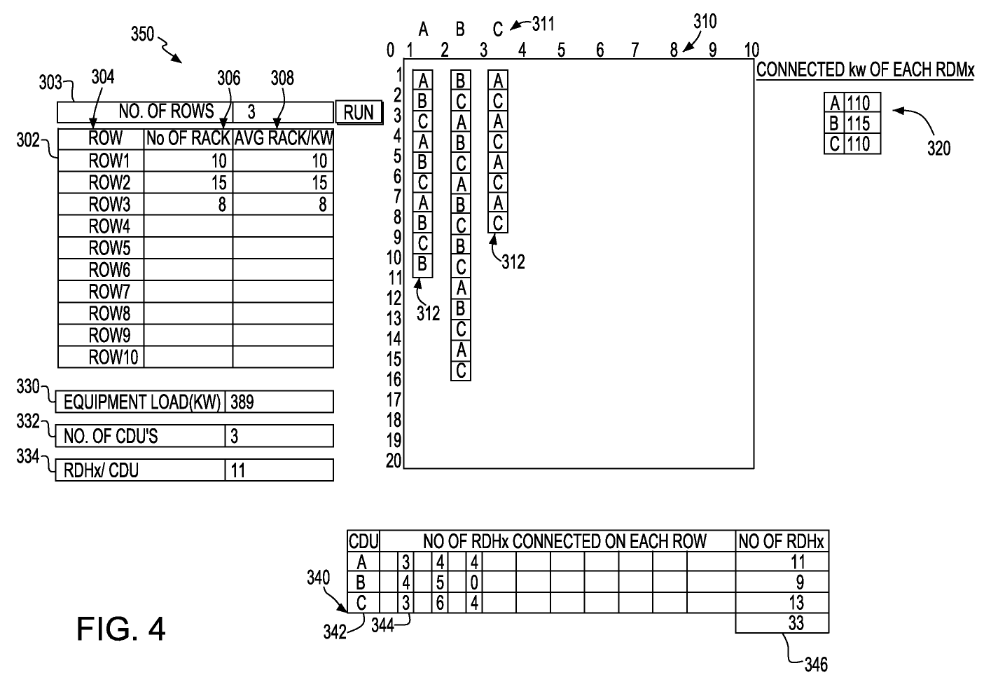

The component layout 102 may include distributing units 120 for pumping coolant at locations adjacent to the corners of the datacenter 100. Such positioning may start from the top corner of the datacenter. Each distribution units shell design may have a minimum distance of 6 inch to 10 ft between distribution units. One way to identify different distribution units is with a unique name and color being automatically assigned, for example the same name and color is given to the racks which are connected with the same distribution units, as shown in FIGS. 3 and 4. Alternate racks may connect to different distribution units to implement and maintain redundancy, that is, having multiple distribution units connected to one row in a redundant design.

Further referring to FIG. 2, the system 90 may include the computer having the processor for executing the software program tool 206. The inputted data may include data center parameters including data center dimensions, and data center square footage. The data center component layout design 210 includes the data center 100 having the plurality of components, and includes positioning the plurality of components including heat generating units. The cooling system layout for the components of the data center 100 are also generated by the software program tool using calculated requirements for the cooling system (e.g., cooling units 112) for the data center component layout in the data center. The data center component layout design 210 includes the positioning of the components and positioning of the cooling system generated by the software program tool.

The system 90 may include the cooling system having communication connections between distribution units 120 and cooling units 112; and piping distribution including connections between heat generating units (e.g., component 108) and the cooling units. The data center parameters may further include one or more of: data center component dimensions; rack dimensions and rack layout; and data based on the piping distribution. The data center parameters may further include: data based on a subfloor of the data center; and dimensions of the subfloor.

The method 10 includes in step 14 inputting data for the data component layout 102 into the computer 200 which executes the software program tool 206 using the processor 202. The input data may include data center parameters which include data center dimensions, and data center square footage; distribution unit capacity, the number of racks; the number of rack per row of racks; and the average rack or row of racks.

When the software tool is initiated in step 22, the software tool 206 generates a data center component layout design 210 in steps 22 and 26 of the method 10. The software tool data input or input parameters may include: a) a maximum capacity of the distribution units (for example including details from product manufacture); b) the number of rows (based on the data center (DC) layout); c) the number of racks per row of racks; and d) the average rack per row in a specific design.

Further, the software tool 206 may calculate and output (in steps 22 and 26 of the method 10) the following parameters for the data center layout design 210 for the data center 100 and example layout 102. The software tool 206 includes: calculating cooling system requirements for the component layout; generating a cooling system layout for the components of the data center; and generating a data center layout including the component layout and the cooling system layout. The data center layout plan 210 which is outputted from the software tool, may include: a) a proposed datacenter layout; b) a positioning of distribution units; c) connection details between distribution units to racks; d) a summary of the number of racks connected with distribution units; and e) a connected load of each of the distribution units. The data center layout may also include: components dimensions; rack dimensions and rack layout; connections between distribution units; piping distribution; and connections between heat generating units (or pumping units), such as the components, and cooling units. The software tool 206 may also calculate for potential failures in cooling systems including the distribution units, and provide solutions in the layout design, for example, providing redundancies within the cooling system.

The method of the present disclosure includes the benefits of providing a data center layout 210 which is plotted automatically, including where distribution units also are positioned automatic sing the tool 206. Depending on the rack load, the distribution units may be connected with a rear door heat exchanger this will be automatically highlighted in the data center layout design 210. A summary report may be generated for each of the distribution units and rear door heat exchangers, wherein the report can be used in a presentation of the data center layout. In one example of the method 10, ten rows of racks can be implemented in a layout design, and in another example twenty rows of racks can be implemented in a layout design.

Other considerations which can be inputted into the software tool in step 14, and receive an output embodied in a component layout of a data center, include: 4. The method of claim 1, wherein data center parameters further include one or more of: whether the data center includes a subfloor; and dimensions of the subfloor.

In another alternative, the method 10 may iteratively calculating an optimized data center layout after updating data based or corresponding to one or more of the cooling requirements or the cooling system layout to generate multiple proposed data center layouts. Further, the data or parameters inputted into the software tool 206 in step 14 of the method 10 may be prioritized, for example, highest priority to lowest priority, and the order may include the following: cooling; and maximized use of space.

Thereby, the method of the disclosure provides an automatic design tool for generating a data center component layout which may include piping distribution and connections between a heat generating unit (or pumping unit) to a cooling unit (or module). Further, the method of the present disclosure provides automated piping distribution design with desirable redundancy to prevent cooling failures and resultant server breakdown in the event of a pumping/central distribution unit failure.

Referring to FIGS. 3 and 4, examples of a data center layout designs 300, 350 have like reference numerals for the same features. The layout designs 300, 350 include a chart 302 which has a heading 303 and includes a column 304 listing each of the rows of racks of components. Thereby, rows 1-10 are listed in column 304. The number of the racks 104 (FIG. 2) are listed in column 306 in each row. Column 308 lists the average heat generation (in KW) of each of the corresponding racks in a row. Row 330 summarizes the equipment load in kilo Watts. Row 332 depicts the total number of distribution units or central distribution units (CDU's). Row 334 depicts the number of heat exchangers (for example, rear door heat exchangers (RDHx) per distribution units. In one embodiment of the invention the data center component layout design includes ten rows of server racks, and each row may include twenty server racks.

Another chart 310, shows a plurality of distribution units 120 in row 311 using letters A-E. Columns 312 depict racks 104 with components, which are designed by letters A-E to correspond to its corresponding distribution unit. Chart 320 depicts distribution units A-E with corresponding kW usage for each heat exchanger 112. A summary report in the form of a chart 340 includes a column 342 depicting the distribution units A-E, related to corresponding number of heat exchangers connected on each row (shown in chart 302) as shown in columns 344. Column 346 depicts the total number of heat exchangers for each of the distribution units shown in column 342.

Referring to FIG. 4, three distribution units (A-C) are shown in row 311 of chart 310. The rack designation in columns 312 of chart 310 is similar to that which is shown in FIG. 3, except using three distribution units (A-C).

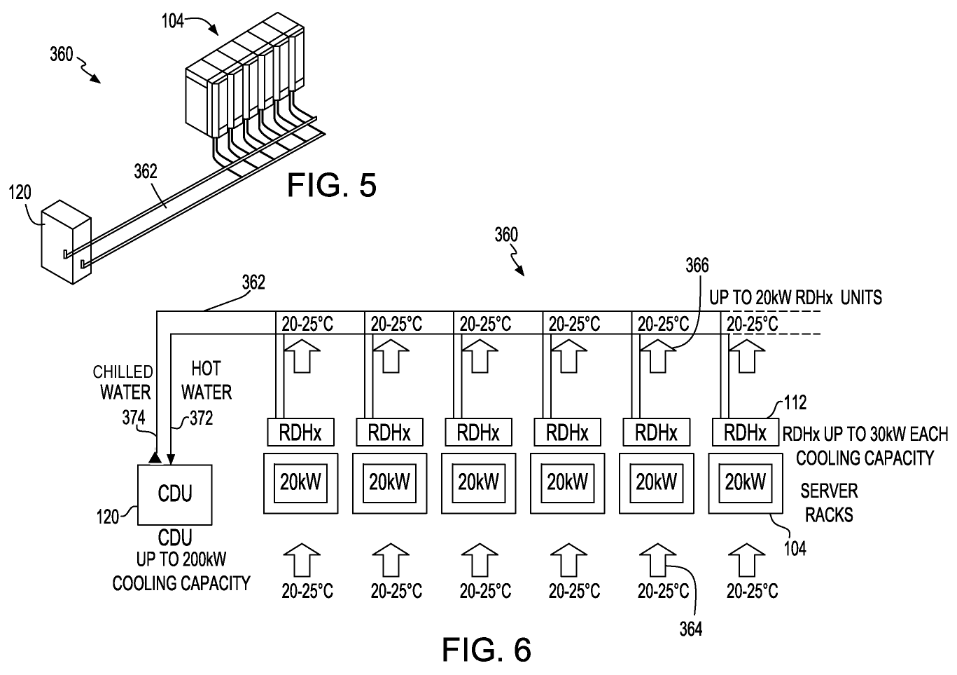

Referring to FIGS. 5 and 6, an embodiment of a layout 360 includes six racks 104 connected to a central distribution unit (CDU) 120 via piping distribution 362. As shown in FIG. 6, the server racks 104 consume about 20 kW of power, wherein water temperature is maintained at about 20-25 degrees Celsius at water temperature input 364 and output 366, using rear door heat exchangers 112 and piping distribution 362. The central distribution unit 120 has a hot water input 372 and a chilled water output 374 at respective terminal ends of the piping distribution 362. The CDU 120 may have a cooling capacity of up to 200 kW.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction implementation system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams/schematic diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

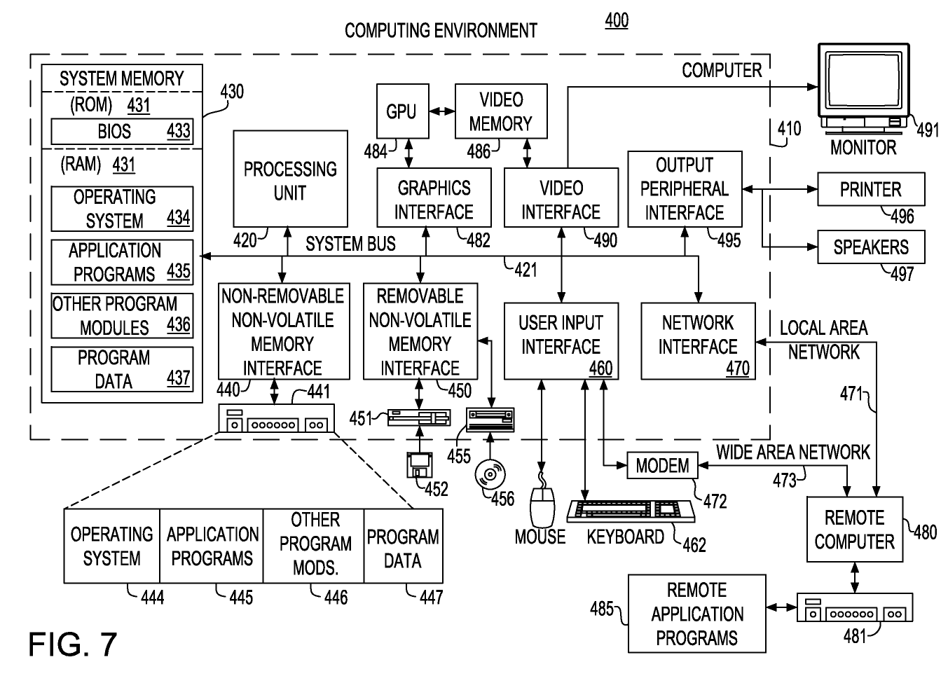

For example, referring to FIG. 7 and the following discussion provide a general description of a suitable computing environment in which the invention may be implemented. It should be understood, however, that handheld, portable, and other computing devices of all kinds are contemplated for use in connection with the present invention. While a general-purpose computer is described below, this is but one example, the present invention may be implemented in an environment of networked hosted services in which very little or minimal client resources are implicated, e.g., a networked environment in which the client device serves merely as a browser or interface to the World Wide Web.

Although not required, the invention can be implemented via an application-programming interface (API), for use by a developer, and/or included within the network browsing software, which will be described in the general context of computer-executable instructions, such as program modules, being run or executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations.

Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 7, thus, illustrates an example of a suitable computing system environment 400 in which the invention may be implemented, although as made clear above, the computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

With reference to FIG. 7, an exemplary system for implementing the invention includes a general purpose-computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 410.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/nonvolatile computer storage media. By way of example only, FIG. 7 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4 provide storage of computer readable instructions, data structures, program modules and other data for the computer 410. In FIG. 7, for example, hard disk drive 441 is illustrated as storing operating system 444, application programs 445, other program modules 446, and program data 447. Note that these components can either be the same as or different from operating system 434, application programs 435, other program modules 436, and program data 437. Operating System 444, application programs 445, other program modules 446, and program data 447 are given different numbers here to illustrate that, at a minimum, they are different copies.

A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB).

A monitor 491 or other type of display device is also connected to the system bus 421 via an interface, such as a video interface 490. A graphics interface 482, such as Northbridge, may also be connected to the system bus 421. Northbridge is a chipset that communicates with the CPU, or host-processing unit 420, and assumes responsibility for accelerated graphics port (AGP) communications. One or more graphics processing units (GPUs) 484 may communicate with graphics interface 482. In this regard, GPUs 484 generally include on-chip memory storage, such as register storage and GPUs 484 communicate with a video memory 486. GPUs 484, however, are but one example of a coprocessor and thus a variety of co-processing devices may be included in computer 410. The monitor 491 or other type of display device is also connected to the system bus 421 via an interface, such as a video interface 490, which may in turn communicate with video memory 486. In addition to monitor 491, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 7 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 7 illustrates remote application programs 485 as residing on memory device 481. It will be appreciated that the network connections shown are exemplary and other means of establishing a communications link between the computers may be used.

One of ordinary skill in the art can appreciate that a computer 410 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and implementation capabilities.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for generating a data center component layout, comprising:
inputting data into a computer, the computer having a processor for executing a software program tool embodied therein, the inputted data including data center parameters including data center dimensions, and data center square footage, and the processor executing the steps of the software program tool including the following steps;
generating a data center component layout of a data center having a plurality of components, the data center component layout positioning the plurality of components, the components including heat generating units;
calculating requirements for a cooling system for the component layout in the data center;
generating a cooling system layout for the components of the data center; and
generating a data center component layout design including the positioning of the components and positioning of the cooling system.

2. The method of claim 1, further comprising:
calculating an optimized data center component layout design, after updating the inputted data based on one or more of the cooling system requirements or the cooling system layout.

3. The method of claim 1, wherein the cooling system includes: communication connections between distribution units and cooling units; piping distribution including connections between heat generating units and the cooling units.

4. The method of claim 3, wherein the data center parameters further include one or more of: data center component dimensions; rack dimensions and rack layout; and data based on the piping distribution.

5. The method of claim 1, wherein the data center parameters further include: data based on a subfloor of the data center; and dimensions of the subfloor.

6. The method of claim 1, further comprising:
iteratively calculating an optimized data center layout design after updating inputted data based on one or more of the cooling requirements or the cooling system layout to generate multiple proposed data center layout designs.

7. The method of claim 1, further comprising:
generating an optimal data center layout design based on prioritized data center parameters.

8. The method of claim 7, wherein the prioritized data center parameters are prioritized, highest priority to lowest priority, in including the following order: cooling; and maximizing use of space.

9. A computer program product comprising a non-transitory computer readable medium having recorded thereon a computer program, a computer system including a processor for executing the steps of the computer program for generating a data center component layout, the program steps comprising:
generating a component layout for a data center having a plurality of components, the components including heat generating units, the generated component layout using inputted data into the computer system for the data center component layout, the inputted data including data center parameters including data center dimensions, and data center square footage;
calculating requirements for a cooling system for the component layout in the data center;
generating a cooling system layout for the components of the data center; and
generating a data center component layout design including the positioning of the component and positioning of the cooling system.

10. The computer programming product of claim 9, further comprising:
calculating an optimized data center component layout design, after updating the inputted data based on one or more of the cooling system requirements or the cooling system layout.

11. The computer programming product of claim 9, wherein the cooling system includes: communication connections between distribution units and cooling units; piping distribution including connections between heat generating units and the cooling units.

12. The computer programming product of claim 11, wherein the data center parameters further include one or more of: data center component dimensions; rack dimensions and rack layout; and data based on the piping distribution.

13. The computer programming product of claim 9, wherein the data center parameters further include: data based on a subfloor of the data center; and dimensions of the subfloor.

14. The computer programming product of claim 9, further comprising:
iteratively calculating an optimized data center layout design after updating inputted data based on one or more of the cooling requirements or the cooling system layout to generate multiple proposed data center layout designs.

15. The computer programming product of claim 9, further comprising:
generating an optimal data center layout design based on prioritized data center parameters.

16. The computer programming product of claim 9, wherein the prioritized data center parameters are prioritized, highest priority to lowest priority, in including the following order: cooling; and maximizing use of space.

17. A system for generating a data center component layout, comprising:
a computer for receiving input data, the computer having a processor for executing a software program tool embodied therein, the inputted data including data center parameters including data center dimensions, and data center square footage, and the processor for executing the steps of the software program tool;
a data center component layout of a data center having a plurality of components generated by the software program tool, the data center component layout positioning the plurality of components, the components including heat generating units,
a cooling system layout for the components of the data center generated by the software program tool using calculated requirements for a cooling system for the data center component layout in the data center; and
a data center component layout design including the positioning of the components and positioning of the cooling system generated by the software program tool.

18. The system of claim 17, wherein the cooling system includes: communication connections between distribution units and cooling units; piping distribution including connections between heat generating units and the cooling units.

19. The system of claim 17, wherein the data center parameters further include one or more of: data center component dimensions; rack dimensions and rack layout; and data based on the piping distribution.

20. The system of claim 17, wherein the data center parameters further include: data based on a subfloor of the data center; and dimensions of the subfloor.
